(19) United States
(12) Patent Application Publication
(10) Pub. No.: US 2005/0147324 A1
(43) Pub. Date: Jul. 7, 2005

(54) Refinements to the Rational Polynomial Coefficient camera model

(76) Inventors: Leong Keong Kwoh, Singapore (SG); Xiao Jing Huang, Singapore (SG); Soo Chin Liew, Singapore (SG)

Correspondence Address: DINSMORE & SHOHL LLP;One Dayton Centre, Suite 1300, One South Main Street, Dayton, OH, 45402-2023, US

(21) Appl. No.: 10/970,692

(22) Filed: Oct. 21, 2004

Related U.S. Application Data
(60) Provisional application No. 60/512,693, filed on Oct. 21, 2003.

(51) Int. Cl. G06K 9/32; G06K 9/00

(52) U.S. Cl. 382/293; 382/154

(57) ABSTRACT

An RPC camera model is applied to a set of intermediate object-space coordinates, where the intermediate object-space coordinates are determined by scaling, translating and rotating original object-space coordinates. The resulting image-space coordinates may be seen to more accurately remove residual error or bias that may exist for one or more of the imaging parameters on which the RPC camera model is based. The RPC camera model thus refined may then be used for photogrammetric processing of associated satellite imagery, including block adjustment, 3D feature extraction and orthorectification. Alternatively, a new RPC camera model (i.e., new coefficients) may be determined based on scaling, translating and rotating parameters. The new RPC camera model may then be applied to the original object-space coordinates to determine image-space coordinates.

### CROSS REFERENCE TO RELATED APPLICATIONS

The present application claims the benefit of prior provisional application Ser. No. 60/512,693 filed Oct. 21, 2003.

### FIELD OF THE INVENTION

The present invention relates to the transformations of three-dimensional object-space coordinates into two dimensional image-space coordinates and, more particularly, to refinements to the Rational Polynomial Coefficient camera model often used to perform such transformations.

### BACKGROUND

Photogrammetry may be defined as the science of using aerial photographs and other remote sensing imagery to obtain measurements of natural and human-made features on the Earth. It is known that remote sensing sensors produce images. Additionally, the organizations that collect the imagery also record physical imaging parameters to accompany the imagery. Such physical imaging parameters may include, for instance, orbital data, sensor (camera) attitude data, focal length and data timing. These physical imaging parameters are unique to each satellite and each sensor and are useful in producing a rigorous camera model that may be used to obtain measurements of natural and human-made features on the Earth based on the imagery. In other words, the camera model may be used to relate object-space (ground) coordinates to image-space coordinates.

Accordingly, for those that purchase or otherwise obtain imagery data from a remote sensing satellite, to correctly interpret the imagery data, it is required to have camera model for the sensor that generated the data.

One type of camera model may be characterized as a set of functions that relates a point expressed as three object-space (ground) coordinates, namely, Latitude, Longitude and Height (P, L, H) (or Easting, Northing and Height or Elevation), to a corresponding point in an image, expressed as two image-space coordinates, namely, “pixel sample” and “line” (X, Y) as follows:
X=ƒ(P,L,H) (1)
Y=g(P,L,H) (2)
where the functions ƒ( ) and g( ) are functions dependent upon the physical imaging parameters.

The organizations that collect and distribute the imagery are often reluctant to disclose all of the physical imaging parameters that are useful in producing a rigorous camera model. Instead, such organizations accompany satellite imagery with a camera model defined by functions of object-space coordinates, where the functions are derived from the physical imaging parameters that relate to the satellite imagery provided.

In a modem sensor, particularly a satellite-based sensor, the majority of such physical imaging parameters are well measured. However, a small residual error or bias may exist for one or more of the physical imaging parameters, which may lead to corresponding errors in the image-space coordinates and, as a consequence, errors in an image produced using the image-space coordinates.

Improvements to the geometric accuracy of a given camera model are typically attempted through an effort to reduce the residual error and biases of the imaging parameters. In particular, usually with the use of ground control points (GCPs). The use of GCPs involves knowledge of object-space coordinates of a given GCP as well as the image-space coordinates of the same GCP. The known object-space coordinates may be processed by a given camera model to produce a determined pair of image-space coordinates. A difference between the determined pair of image-space coordinates and the known pair of image-space coordinates may then be used to adjust the imaging parameters. The imaging parameters may be adjusted, and, as a consequence, the camera model is adjusted, using a least squares algorithm with a goal of minimizing the difference between the determined pair of image-space coordinates (determined using the adjusted camera model) and the known pair of image-space coordinates.

Alternatively, it is known to perform bundle adjustments, wherein one or more adjacent images are compared and adjustments to the imaging parameters are determined that minimize relative bias between the adjacent images.

One camera model that has gained considerable interest in photogrammetry and the processing of remote sensing satellite imagery of late is called the Rational Polynomial Coefficient (RPC) camera model. The RPC camera model has been shown to be a simple and effective way to approximate a rigorous camera model. In particular, the Cubic RPC camera model has been shown to be able to accurately approximate a rigorous camera model to an accuracy of better than 0.02 pixels (see Hartley, Richard I. and Saxena, Tushar, “The Cubic Rational Polynomial Camera Model”, Sep. 11, 2000, www.cs.albany.edu/˜saxena/Papers/cubic.pdf), even for a non-perspective Synthetic Aperture Radar (SAR) sensor.

The RPC camera model allows an end user of satellite imagery accompanied by the RPC camera model to perform full photogrammetric processing of the satellite imagery, including block adjustment, 3D feature extraction and orthorectification.

The RPC camera model is a camera model that relates a ground point expressed in object-space coordinates (P, L, H) to a corresponding point in an image expressed in image-space coordinates (X, Y). In the RPC camera model, the various imaging parameters are used to determine four polynomials that are used as follows:

$$\begin{matrix}X = \frac{{ρ}_{1} ( P , L , H )}{{ρ}_{2} ( P , L , H )} & ( 3 ) \\ Y = \frac{{ρ}_{3} ( P , L , H )}{{ρ}_{4} ( P , L , H )} & ( 4 )\end{matrix}$$

where (P, L, H) is a set of normalized coordinates of latitude, longitude and height in object (ground) space. The normalized coordinates are obtained by applying a linear scaling factor and a linear translation factor to the corresponding actual coordinates of latitude, longitude and height in object-space to limit the magnitude of each coordinate of the normalized set to a predetermined range.

The image-space coordinates (X, Y) resulting from the application of the RPC camera model may be considered to be “normalized” sample and line coordinates in image-space. A pair of “actual” sample and line coordinates in image-space may be obtained by applying a reverse scaling factor to a respective pair of normalized sample and line coordinates.

Each of the four polynomials ρ₁, ρ₂, ρ₃, ρ₄ used in the RPC camera model may be expressed generically as follows:

$$\begin{matrix}ρ ( P , L , H ) = {\sum }_{i = 0}^{N - j - k} {\sum }_{j = 0}^{N - i - k} {\sum }_{k = 0}^{N - i - j} {C}_{ijk} {P}^{i} {L}^{j} {H}^{k} \\ = {C}_{000} + {C}_{010} \cdot L + {C}_{100} \cdot P + {C}_{001} \cdot H + {C}_{110} \cdot L \cdot P + \\ {C}_{011} \cdot L \cdot H + {C}_{101} \cdot P \cdot H + {C}_{020} \cdot {L}^{2} + {C}_{200} \cdot {P}^{2} + \\ {C}_{002} \cdot {H}^{2} + {C}_{111} \cdot L \cdot P \cdot H + {C}_{030} \cdot {L}^{3} + {C}_{210} \cdot L \cdot {P}^{2} + \\ {C}_{012} \cdot L \cdot {H}^{2} + {C}_{120} \cdot {L}^{2} \cdot P + {C}_{300} \cdot {P}^{3} + {C}_{102} \cdot P \cdot {H}^{2} + \\ {C}_{021} \cdot {L}^{2} \cdot H + {C}_{201} \cdot {P}^{2} \cdot H + {C}_{003} \cdot {H}^{3} \\ = {C}_{0} + {C}_{1} \cdot L + {C}_{2} \cdot P + {C}_{3} \cdot H + {C}_{4} \cdot L \cdot P + \\ {C}_{5} \cdot L \cdot H + {C}_{6} \cdot P \cdot H + \\ {C}_{7} \cdot {L}^{2} + {C}_{8} \cdot {P}^{2} + {C}_{9} \cdot {H}^{2} + {C}_{10} \cdot L \cdot P \cdot H + \\ {C}_{11} \cdot {L}^{3} + {C}_{12} \cdot L \cdot {P}^{2} + {C}_{13} \cdot L \cdot {H}^{2} + {C}_{14} \cdot {L}^{2} \cdot P + \\ {C}_{15} \cdot {P}^{3} + {C}_{16} \cdot P \cdot {H}^{2} + {C}_{17} \cdot {L}^{2} \cdot H + \\ {C}_{18} \cdot {P}^{2} \cdot H + {C}_{19} \cdot {H}^{3}\end{matrix} \qquad ( 5 )$$

where the order of each term is limited to N. The order, N, is usually three (cubic) and the 20 coefficients, C₀-C₁₉, of the rational polynomial function, ρ(P,L,H), are derived from measured sensor imaging parameters. As such, the coefficients may be called “a-priori” parameters.

The RPC camera model has an advantage in that it allows satellite operators to withhold certain confidential sensor information without denying the public use of the satellite imagery. However, this feature also means that the imaging parameters may not be directly adjusted to perform adjustments to the RPC camera model.

The coefficients of the RPC camera model may be provided in conjunction with a satellite image. To improve the geometric accuracy of the image-space coordinates determined using the RPC camera model, it may be required to estimate and remove residual errors or biases in the coefficients, rather than the residual errors or biases in the imaging parameters from which the coefficients were derived. The estimating and removing may be accomplished by adjusting the coefficients of the RPC camera model such that when the adjusted RPC camera model is applied to the GCP object-space coordinates, the resulting image-space coordinates more closely approximate the GCP image-space coordinates. Alternatively, the estimating and removing errors or biases in the coefficients of the RPC camera model may be accomplished by through bundle adjustments with overlapping imagery, as briefly discussed above.

For a cubic RPC camera model that has, for example, 80 coefficients (20 coefficients for each of four polynomials), the adjustment of all 80 coefficients, using standard least squares adjustments, is known to require a considerable number (40) of GCPs. Refinement of the RPC camera model in such a case may be considered to be impractical.

Without removing the biases of imaging parameters, it may be shown that one can still improve the geometric accuracy of images produced using a given camera model either (a) by performing a post-processing step to adjust the determined image-space coordinates, i.e.,

$$\begin{matrix}X = \frac{{ρ}_{1} ( P , L , H )}{{ρ}_{2} ( P , L , H )} + Δ X and \\ Y = \frac{{ρ}_{3} ( P , L , H )}{{ρ}_{4} ( P , L , H )} + Δ Y ,\end{matrix}$$

or (b) by performing a pre-processing function to adjust the image-space coordinates using adjustable functions Δx and Δy to obtain adjusted image-space coordinates X′ and Y′ from
X′=X+Δx
Y′=Y+Δy
so that:

$$\begin{matrix}{X}^{′} = \frac{{ρ}_{1} ( P , L , H )}{{ρ}_{2} ( P , L , H )} and \\ {Y}^{′} = \frac{{ρ}_{3} ( P , L , H )}{{ρ}_{4} ( P , L , H )}\end{matrix}$$

(see Fraser, Clive S. and Hanley, Harry B., “Bias Compensation in Rational Functions for IKONOS Satellite Imagery”, Photogrammetric Engineering and Remote Sensing, Vol. 69, No. 1, January 2003, pp. 53-57 and Grodecki, Jacek and Dial, Gene, “Block Adjustment of High-Resolution Satellite Images Described by Rational Polynomials”, Photogrammetric Engineering and Remote Sensing, Vol. 69, No. 1, January 2003, pp. 59-68). The adjustable functions Δx and Δy are typically polynomials of the image coordinates, X and Y. Such methods are known to be particularly applicable to a system with a narrow field of view imaging a relatively flat area.

In another approach, in U.S. patent application Ser. No. 09/846,621, filed May 1, 2001, Dial Jr. et al propose method of adjusting the object space coordinates that involves the addition of an adjustment term to each of the three object space coordinates. Each adjustment term is approximated by a cubic polynomial function of the object space coordinates. The Dial Jr. adjustment method requires determination, and optimization, of altogether 60 coefficients of the cubic polynomial functions.

Clearly, refinements to the RPC camera model are required that will be valid for systems with a large field of view and moderately hilly terrain.

### SUMMARY

Refinements to a given RPC camera model may be accomplished by determining intermediate object-space coordinates from given object-space coordinates and applying the given RPC camera model with a provided set of coefficients to the intermediate object-space coordinates to determine image-space coordinates. The intermediate object-space coordinates are determined as functions of the given object-space coordinates and physical parameters so as to remove the biases in the provided set of coefficients.

Advantageously, the use of physical parameters allows the method to be valid for large field of view systems imaging moderately hilly terrain. Existing RPC refinement algorithms, based on polynomial fitting of image coordinate residuals, are known to only be valid for narrow field of view systems and flat terrain.

In accordance with an aspect of the present invention there is provided a method of refining a Rational Polynomial Coefficient (RPC) camera model. The method includes receiving an original plurality of coefficients defining an original Rational Polynomial Coefficient (RPC) camera model for determining image-space coordinates from object-space coordinates defined for an original object-space coordinate system, determining a plurality of physical parameters for transforming the original object-space coordinate system to an intermediate object-space coordinate system and, based on the plurality of physical parameters and the original plurality of coefficients, determining a refined plurality of coefficients defining a refined RPC camera model. In another aspect of the present invention, a computer readable medium is provided to allow a general purpose computer to carry out this method.

In accordance with another aspect of the present invention there is provided a method of refining a Rational Polynomial Coefficient (RPC) camera model. The method includes receiving an original plurality of coefficients defining an original Rational Polynomial Coefficient (RPC) camera model for determining image-space coordinates from object-space coordinates defined for an original object-space coordinate system, receiving a plurality of known object-space coordinates in the original object-space coordinate system and a plurality of known image-space coordinates corresponding to the plurality of known object-space coordinates and determining a plurality of physical parameters for transforming the original object-space coordinate system to an intermediate object-space coordinate system to reduce a difference between: the known image-space coordinates; and a plurality of image-space coordinates determined through application of the original RPC camera model to object-space coordinates of the known object-space coordinates that correspond to the known image-space coordinates and have been transformed to the intermediate object space coordinate system. The method further includes, based on the plurality of physical parameters and the original plurality of coefficients, determining a refined plurality of coefficients defining a refined RPC camera model. In another aspect of the present invention, a computer readable medium is provided to allow a general purpose computer to carry out this method.

In accordance with a further aspect of the present invention there is provided a method of determining a pair of image-space coordinates. The method includes receiving a plurality of coefficients defining a Rational Polynomial Coefficient (RPC) camera model, receiving a plurality of values for original object-space coordinates, where the plurality of values for original object-space coordinates are defined for an original object-space coordinate system, determining values for a plurality of intermediate object-space coordinates in an intermediate object-space coordinate system, where the intermediate object-space coordinate system is adjusted relative to the original object-space coordinate system, and utilizing the values for the plurality of intermediate object-space coordinates in the RPC camera model to obtain a pair of image-space coordinates. In another aspect of the present invention, a computer readable medium is provided to allow a general purpose computer to carry out this method.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates the known object-space coordinate system;

FIG. 2 illustrates adjustments to the known object-space coordinate system, according to an embodiment of the present invention;

FIG. 3 illustrates steps in a method of producing image-space coordinates from object-space coordinates and RPC coefficients, according to an embodiment of the present invention;

FIG. 4 illustrates steps in a parameter optimization method according to an embodiment of the present invention;

FIG. 5 illustrates steps in an alternative method to that of FIG. 3 of producing image-space coordinates from object-space coordinates and RPC coefficients, according to an embodiment of the present invention; and

FIG. 6 illustrates steps in a coefficient determining step as part of the method of FIG. 5.

### DETAILED DESCRIPTION

In the RPC camera model, since the various imaging parameters are already represented by the coefficients, it is not possible to, for instance, directly adjust the translational imaging parameters and the rotational imaging parameters. The cubic RPC camera model is defined by four functions involving 80 coefficients. To refine the cubic RPC camera model may require adjustments to 78 of the 80 coefficients (two coefficients are known to be equal to 1), which, as stated previously, may require the processing of at least 40 ground control points.

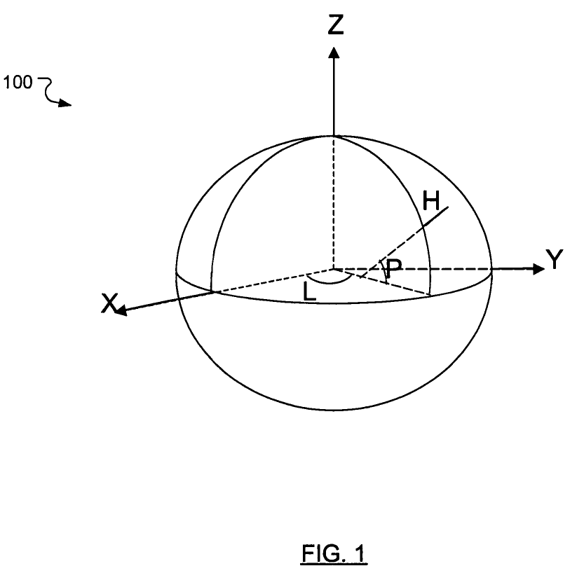

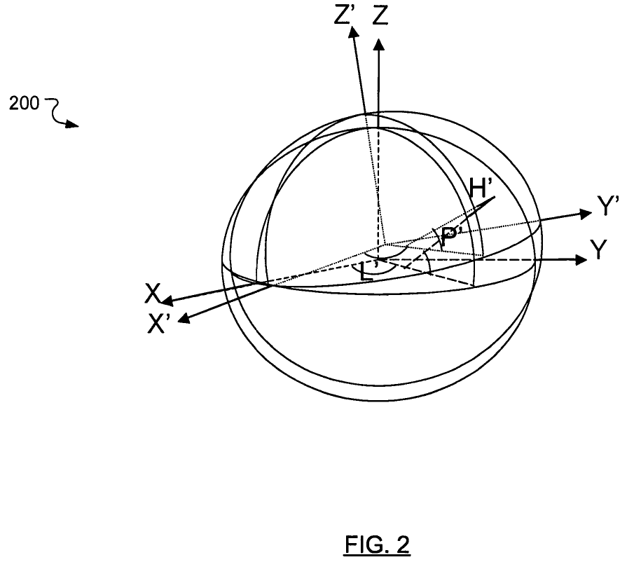

In overview, instead of translating, rotating and scaling imaging parameters that describe the sensor system to remove the biases in the measured imaging parameters (the traditional approach that cannot be accomplished for the RPC camera model), the object-space (ground) coordinate system (illustrated in FIG. 1) may be mathematically rotated, translated and scaled (as illustrated in FIG. 2) in an attempt to remove the biases in the biased, a-priori sensor imaging parameters. The adjustment of the object-space coordinate system may be implemented as an adjustment, using nine physical parameters, of object-space coordinates before the application of the given RPC camera model. Refining the RPC camera model then only requires adjustments to nine physical parameters and, therefore, processing of significantly fewer ground control points. The RPC camera model thus refined may then be used for photogrammetric processing of associated satellite imagery, including block adjustment, 3D feature extraction and orthorectification.

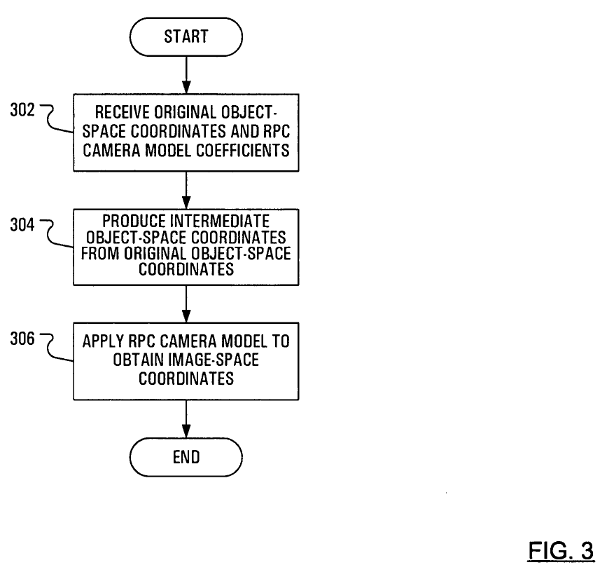

Operation of an aspect of the invention is illustrated in FIG. 3 to begin with the receipt (step 302) of a set of original object-space data and a set of coefficients for use in a Rational Polynomial Coefficient (RPC) camera model. In particular, the set of original object-space data may be for a given ground control point, which also includes pair of image-space coordinates (X_{q},Y_{q}) that corresponds to the set of object-space coordinates (P_{q},L_{q},H_{q}).

Subsequently, a set of intermediate object-space coordinates (P′_{q},L′_{q},H′_{q}) may be determined from the set of original object-space coordinates (step 304). The RPC camera model with the set of coefficients is then applied to the set of intermediate object-space coordinates to result in a pair of image-space coordinates (step 306).

Mathematically, an intermediate object-space coordinate system is introduced, which is a translated, rotated and scaled version of the original object-space coordinate system such that applying the RPC camera model to the intermediate object-space coordinates results in improved geometric accuracy in the resulting image-space coordinates. The intermediate object-space coordinates (P′,L′,H′) are determined (step 304) from the original object-space coordinates (P,L,H) as follows:

$$[ \begin{matrix}{P}^{′} \\ {L}^{′} \\ {H}^{′}\end{matrix} ] = [ \begin{matrix}{P}_{0} \\ {L}_{0} \\ {H}_{0}\end{matrix} ] + [ \begin{matrix}1 + {s}_{1} & 0 & 0 \\ 0 & 1 + {s}_{2} & 0 \\ 0 & 0 & 1 + {s}_{3}\end{matrix} ] [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}P \\ L \\ H\end{matrix} ] \qquad ( 6 )$$

where (P₀,L₀,H₀) are physical parameters, called “translating factors,” for adjusting latitude, longitude and height, respectively, (s₁,s₂,s₃) are physical parameters, called “scaling factors,” for adjusting latitude, longitude and height, respectively, and (m₁₁,m₁₂,m₁₃,m₂₁,m₂₂,m₂₃,m₃₁,m₃₂,m₃₃) are rotating factors that are organized in a rotational matrix determined from physical parameters, called “rotational angles.” The rotational angles include pitch angle, ω, roll angle, φ, and yaw angle, κ. Equation (6) may be expanded to:
P′=P₀+(1+s₁)m₁₁P+(1+s₁)m₁₂L+(1+sₗ)m₁₃H (7)
L′=L₀+(1+s₂)m₂₁P+(1+s₂)m₂₂L+(1+s₂)m₂₃H (8)
H′=H₀+(1+s₃)m₃₁P+(1+s₃)m₃₂L+(1+s₃)m₃₃H (9)

The rotating factors are known to be obtained from the rotational angles (the pitch angle ω, the roll angle φ and the yaw angle κ) in more than one relation. Each relation, however, is known to give similar results. One standard relation follows:

$$[ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] = [ \begin{matrix}cos ω cos κ & - cos φ sin κ + sin φ sin ω cos κ & sin ω sin κ + cos φ sin ω cos κ \\ cos ω sin κ & cos φ cos κ + sin φ sin ω sin κ & - sin φ cos κ + cos φ sin ω sin κ \\ - sin ω & sin φ cos ω & cos φ cos ω\end{matrix} ] . \qquad ( 10 )$$

Translational drift factors \dot{P}, \dot{L} and \dot{H} may be introduced for refining the translating factors, such that the translating factor is determined by summing an initial translating factor with a product of a translational drift factor and a variable factor as follows:
P₀=P₀₀+\dot{P}·t; (11)
L₀=L₀₀+\dot{L}·t; and (12)
H₀=H₀₀+\dot{H}·t. (13)

Rotational drift factors \dot{ω}, \dot{φ} and \dot{κ} may be introduced for refining the pitch, roll and yaw angles, such that the rotational angle is determined by summing an initial rotational angle with a product of a rotational drift factor and a variable factor as follows:
ω=ω₀+\dot{ω}19 t; (14)
φ=φ₀+\dot{φ}·t; and (15)
κ=κ₀+\dot{κ}·t. (16)

For convenience, the variable factor, which is time (t) in equations (11)-(16), can be replaced with the latitude object-space coordinate (P) or the line image-space coordinate (Y) for a scan in the along-track direction and longitude object-space coordinate (L) or pixel sample image-space coordinate (X) for scan in the cross-track direction.

The image-space coordinates X and Y may then be produced (step 306) from the intermediate object-space coordinates (P′,L′,H′) as follows:

$$\begin{matrix}X = \frac{{ρ}_{1} ( {P}^{′} , {L}^{′} , {H}^{′} )}{{ρ}_{2} ( {P}^{′} , {L}^{′} , {H}^{′} )} & ( 17 ) \\ Y = \frac{{ρ}_{3} ( {P}^{′} , {L}^{′} , {H}^{′} )}{{ρ}_{4} ( {P}^{′} , {L}^{′} , {H}^{′} )} & ( 18 )\end{matrix}$$

with (ρ₁,ρ₂,ρ₃,ρ₄) being the same polynomials as those used in the RPC camera model of equations (3) and (4), having the a-priori coefficients supplied with the satellite imagery.

It is known that the physical parameters, including three translating factors, three rotational angles and secondary imaging factors (scaling factors, translational drift factors or rotational drift factors), may be optimized using a least squares technique. Least squares techniques are discussed at www.orbitals.com/self/least/least.pdf as being used to solve a set of linear equations having more equations than unknown variables (i.e., the physical parameters). Since there are more equations than variables, the solution will not be exactly correct for each equation; rather, the process minimizes the sum of the squares of the residual errors.

The formulation presented in equations (6), (11), (12), (13), (14), (15), (16), (17) and (18) may be considered valid for so-called “frame” cameras. However, most imaging satellites (including IKONOS and SPOT) use a linear-array “pushbroom” camera rather than frame camera. In a pushbroom camera, the focal plane is one line of detection, in contrast to a frame camera, wherein the focal plane is a two dimensional image plane. The frame camera formulation above can still be used to refine the RPC model of a pushbroom camera if the errors/bias in the adjustable parameters are small.

A more correct formulation for refinements to the RPC model of a pushbroom camera is detailed below.

If the flight direction is perfectly oriented in the north-south direction, equation (6) can be modified as follows:

$$[ \begin{matrix}{P}^{′} \\ {L}^{′} \\ {H}^{′}\end{matrix} ] = [ \begin{matrix}{P}_{0} \\ {L}_{0} \\ {H}_{0}\end{matrix} ] + [ \begin{matrix}1 + {s}_{1} & 0 & 0 \\ 0 & 1 + {s}_{2} & 0 \\ 0 & 0 & 1 + {s}_{3}\end{matrix} ] [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}0 \\ L \\ H\end{matrix} ] + [ \begin{matrix}P \\ 0 \\ 0\end{matrix} ] \qquad ( 19 )$$

Notably, P is zero in the matrix to which the rotation matrix is applied and is added in later in the equation.

However, it is very unlikely that the flight direction is oriented perfectly in the north-south direction. This lack of perfect north-south orientation may be accounted for by skewing the latitude and longitude coordinates by an orientation angle before applying equation (19) (less the translating factors P₀, L₀ and H₀ terms for convenience) on the skewed latitude and longitude coordinates and then reverse skewing the latitude and longitude coordinates by the same orientation angle. Mathematically, the skewed latitude, Pₛ, and skewed longitude, Lₛ, coordinates are determined through the application of:

$$[ \begin{matrix}{P}_{s} \\ {L}_{s} \\ {H}_{s}\end{matrix} ] = [ \begin{matrix}cos γ & - sin γ & 0 \\ sin γ & cos γ & 0 \\ 0 & 0 & 1\end{matrix} ] [ \begin{matrix}P \\ L \\ H\end{matrix} ] \qquad ( 20 )$$

where Hₛ is the same as H and γ is the orientation angle. The orientation angle γ can be estimated from the arc tangent of the partial derivatives of the image-space coordinates X and Y with respect to latitude, P, as follows:

$$γ = arctan ( \frac{\frac{\partial X}{\partial P}}{\frac{\partial Y}{\partial P}} ) . \qquad ( 21 )$$

Skewed intermediate object-space coordinates (P′ₛ,L′ₛ,H′ₛ) may then be determined, in a manner similar to equation (19), as

$$\begin{matrix}[ \begin{matrix}{P}_{s}^{′} \\ {L}_{s}^{′} \\ {H}_{s}^{′}\end{matrix} ] = [ \begin{matrix}1 + {s}_{1} & 0 & 0 \\ 0 & 1 + {s}_{2} & 0 \\ 0 & 0 & 1 + {s}_{3}\end{matrix} ] [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] [ \begin{matrix}0 \\ {L}_{s} \\ H\end{matrix} ] + \\ [ \begin{matrix}{P}_{s} \\ 0 \\ 0\end{matrix} ] .\end{matrix} \qquad ( 22 )$$

Reverse-skewed intermediate coordinates may then be determined as

$$[ \begin{matrix}{P}^{′} \\ {L}^{′} \\ {H}^{′}\end{matrix} ] = [ \begin{matrix}{P}_{0} \\ {L}_{0} \\ {H}_{0}\end{matrix} ] + [ \begin{matrix}cos γ & sin γ & 0 \\ - sin γ & cos γ & 0 \\ 0 & 0 & 1\end{matrix} ] [ \begin{matrix}{P}_{s}^{′} \\ {L}_{s}^{′} \\ {H}_{s}^{′}\end{matrix} ] \qquad ( 23 )$$

which may be expanded as
P′=P₀+cos γP′ₛ+sin γL′ₛ, (24)
L′=L₀−sin γP′₂+cos γL′ₛ and (25)
H′=H₀+H′ₛ (26)
where cos γ and sin γ may be called “skew factors”.

Final image coordinates X and Y may then be determined from equations (17) and (18) with (ρ₁,ρ₂,ρ₃,ρ₄) being the same polynomials as those used in the RPC camera model of equations (3) and (4), having the a-priori coefficients supplied with a given image.

The physical parameters, including three translating factors, three rotational factors and secondary imaging factors (scaling factors, translational drift factors or rotational drift factors), are similar to the frame camera formulation and, similar to the frame camera formulation, may be optimized using a least squares technique.

The solving for the physical parameters may be accomplished with knowledge of image-space coordinates X and Y that correspond to particular object-space coordinates (P,L,H) . Such knowledge may be provided as described above in the form of ground control points.

The application of the RPC camera model with the provided set of coefficients to a set of intermediate object-space coordinates to result in a pair of image-space coordinates (step 306) may be characterized as “rigorous”. This refinement to the RPC camera model has this characterization in common with the original RPC camera model. It is known in the photogrammetry trade to use the term “rigorous” to describe a technique that does not use (or uses very few when compared to another method) engineered parameters, that is, parameters introduced to promote ease of calculation, even though the engineered parameters have no correspondence to physical entities. At this stage of refinement to the RPC camera model, the physical parameters solved for have physical meaning (rotational angles, translation factors, scaling factors, etc.).

However, processing time may be further reduced by determining a refinement to the RPC camera model that is only semi-rigorous.

In practice, the object-space (ground) coordinates can be in a linear measurement (meters) for Easting or Northing or, more commonly, in degrees of Latitude or Longitude. Notably, the latter units of measure (degrees) are different from the units of measure used for the heights (meters). Furthermore, object-space coordinates used in a given RPC camera model are likely to be normalized with different scaling factors. In the formulations presented above in equations (6), (11), (12), (13), (14), (15), (16), (17) and (18), it is required to carefully maintain awareness of the different units of measure and normalizing scaling factors.

It is proposed, then, to simplify equation (6), and related equations, to remove the self-imposed requirement to minimize the use engineered parameters and thus provide a more generalized solution. With small rotational angles (ω, φ, κ) and scaling factors (s₁,s₂,s₃), equation (6) can be rewritten as:

$$[ \begin{matrix}{P}^{′} \\ {L}^{′} \\ {H}^{′}\end{matrix} ] = [ \begin{matrix}{P}_{0} \\ {L}_{0} \\ {H}_{0}\end{matrix} ] + [ \begin{matrix}{s}_{1} & - κ & ω \\ κ & {s}_{2} & - φ \\ - ω & φ & {s}_{3}\end{matrix} ] [ \begin{matrix}P \\ L \\ H\end{matrix} ] + [ \begin{matrix}P \\ L \\ H\end{matrix} ] , \qquad ( 27 )$$

which may be expanded to:
P′=P₀+s₁·P−κL+ω·H+P (28)
L′=L₀+κ·P+s₂·L−φ·H+L (29)
H′=H₀−ω·P+φ·L+s₃·H+H (30)
and further generalized as:
P′=a₀+a₁·P+a₂·L+a₃·H+P (31)
L′=b₀+b₁·P+b₂·L+b₃·H+L (32)
H′=c₀+c₁·P+c₂·L+c₃·H+H (33)
from which may be identified 12 adjustable coefficients. It is noted that equations (7), (8) and (9), before simplification, can also be expressed in this generalized form with 12 adjustable coefficients. However, not all of the 12 coefficients are independent. The 12 adjustable coefficients are determined based on the nine physical parameters (i.e., three translation factors, three rotation angles and three scaling factors) through equations (7), (8), (9) and (10) before simplification and equations (28), (29) and (30) after simplification.

The 12 adjustable coefficients a₀, a₁, a₂, a₃ , b₀, b₁, b₂, b₃, c₀, c₁, c₂ and c₃ in equations (31), (32) and (33) are directly applicable for a set of normalized object-space coordinates, (P,L,H).

The pushbroom camera formulation of equation (23) may also be simplified into the form as shown in equations (31), (32) and (33) if rotational elements (ω, φ, κ) are small.

For a very high flying sensor, such as satellite, terrain height is small compared to the flying height of the satellite. The terms ω·H, φ·H and s₃19 H (the fourth term in the polynomial in each of equations (28), (29) and (30)) become almost constant (i.e., variations are relatively small) and, thus, can be absorbed into the constant terms a₀, b₀ and c₀. The number of adjustable coefficients for images taken from a satellite or very high flying sensor can thus be reduced to nine such that:
P′=a₀+a₁·P+a₂·L+P (34)
L′=b₀+b₁·P+b₂·L+L (35)
H′=c₀+c₁·P+c₂·L+H (36)
where a₀, a₁, a₂, b₀, b₁, b₂, C₀, c₁ and c₂ are the nine adjustable, yet interrelated, coefficients.

If we are confident that there is no scaling bias, the nine adjustable coefficients can be further reduced to seven adjustable coefficients, with a₁ and b₂ fixed at zero. As will be apparent to a person of skill in the art, under appropriate conditions, any number of the 12 adjustable coefficients may be held fixed.

The intermediate object-space coordinates (P′,L′,H′) determined using the simplified equations (34), (35) and (36) may then be used as a basis for determining the image-space coordinates (X,Y) in equations (17) and (18).

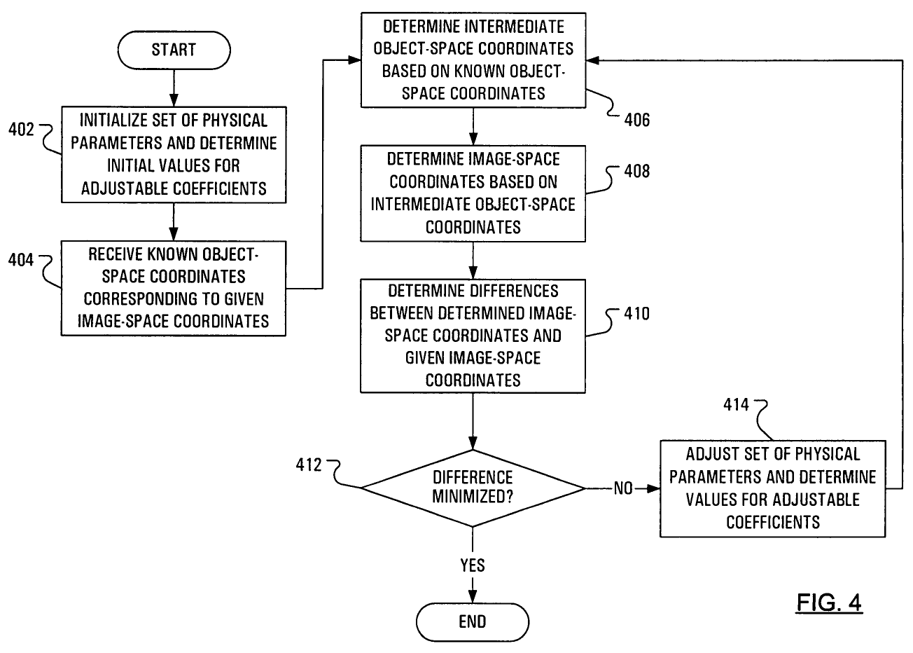

The 12 adjustable coefficients a₀, a₁, a₂, a₃, b₀, b₁, b₂, b₃, c₀, c₁, c₂ and c₃ in equations (31), (32) and (33), may not be optimum as initialized. To optimize the geometric accuracy of the herein-proposed refinements to the RPC camera model, ground control points may be used, as illustrated in the steps of an adjustable coefficient optimization method in FIG. 4. Optimizing the 12 adjustable coefficients for a given sensor begins with initializing the physical parameters (P₀, L₀, H₀, ω, φ, κ, s₁, s₂, s₃) and calculating the initial values of the adjustable coefficients (step 402). The initial values for the adjustable coefficients may be determined according to equations (7), (8), (9) and (10) for the rigorous method and equations (28), (29) and (30) for the semi-rigorous method. A given set of ground control points may be provided to the optimization method as known pairs of image-space coordinates (X_{qi},Y_{qi}) (i=1, 2, . . . , N, where N is the number of control points) that correspond to known sets of object-space coordinates (P_{qi},L_{qi},H_{qi}). Upon receiving the ground control point coordinates (step 404), a set of intermediate object-space coordinates (P′_{qi},L′_{qi},H′_{qi}) may be determined (step 406) using the generalized equations (31), (32), (33) and the known set of object-space coordinates (P_{qi},L_{qi},H_{qi}) Based on sets of determined intermediate object-space coordinates (P′_{qi},L′_{qi},H′_{qi}), corresponding pairs of image-space coordinates (Xᵣᵢ,Yᵣᵢ) may be determined (step 408). An error function representative of a residual error, between the determined image-space coordinates (Xᵣᵢ,Yᵣᵢ) and the known image-space coordinates (X_{qi},_{qi}) may then be determined (step 410). In particular, one such error function that can be used is the root-mean-square (rms) difference defined by the equation:

$$E = \sqrt{\frac{{\sum }_{i = 1}^{N} [ {( {X}_{ri} - {X}_{qi} )}^{2} + {( {Y}_{ri} - {Y}_{qi} )}^{2} ]}{N}} . \qquad ( 37 )$$

As will be appreciated by those skilled in the art, the rms difference is but one exemplary error function representative of a residual error, and that many other error functions may be used when optimizing the geometric accuracy of the herein-proposed refinements to the RPC camera model.

It is then determined whether the difference has been minimized (step 412). Such a determination may be based on several determinations of difference, or may simply require that the difference be less than a predetermined threshold. Selected ones of the 12 adjustable coefficients may then be adjusted (step 414) by adjusting the values of the physical parameters.(P₀, L₀, H₀, ω, φ, κ, s₁, s₂, s₃) based on one of many known least squares adjustment algorithms or other equivalent algorithm and calculating the corresponding values of the selected ones of the 12 adjustable coefficients.

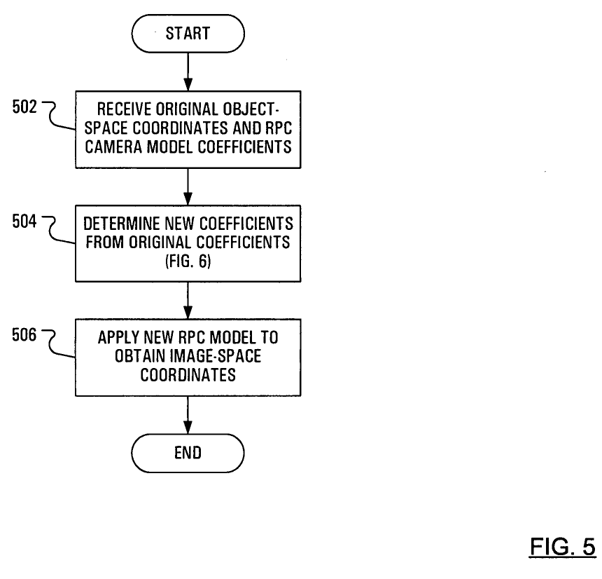

In an alternate aspect of the present invention, rather than apply the provided RPC camera model to a set of intermediate object-space coordinates, a new, refined RPC camera model can be applied to the original object-space coordinates. Operation of this alternate aspect of the present invention is illustrated in FIG. 5 to begin with the receipt of a set of original object-space coordinates and a set of coefficients for use in an original RPC camera model (step 502). Subsequently, a set of new coefficients is determined from the set of original coefficients (step 504). The set of new coefficients defines a new, refined RPC camera model. The new, refined RPC camera model with the new set of coefficients is then applied to the set of original object-space coordinates to result in a pair of image-space coordinates (step 506).

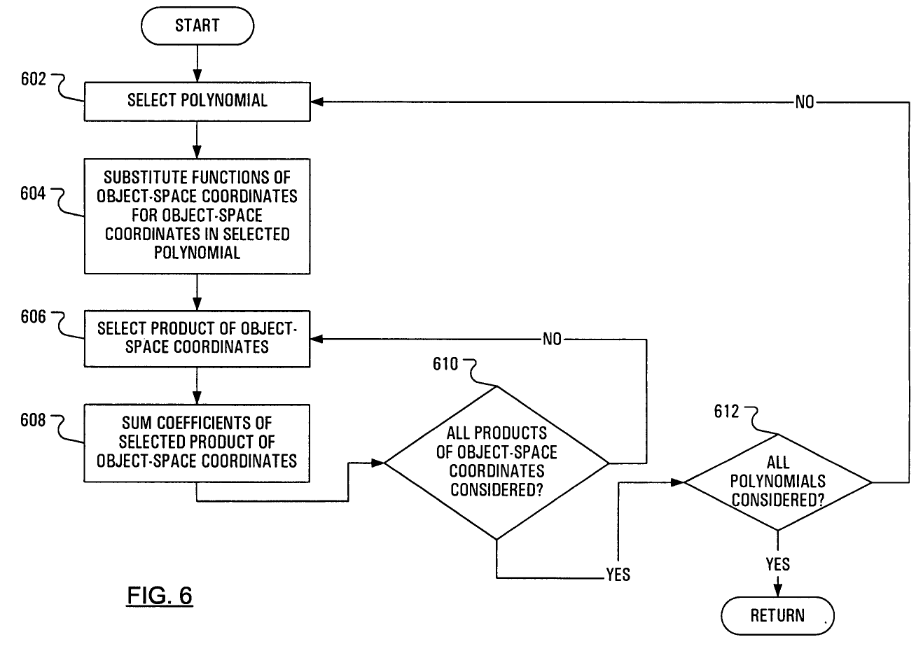

FIG. 6 illustrates steps in the determination of the set of new coefficients from the set of original coefficients (step 504), which involves expanding of each polynomial ρ(P′,L′,H′) to give:

$$\begin{matrix}ρ ( {P}^{′} , {L}^{′} , {H}^{′} ) = {\sum }_{i = 0}^{N - j - k} {\sum }_{j = 0}^{N - i - k} {\sum }_{k = 0}^{N - i - j} {C}_{ijk} {P}^{′ i} {L}^{′ j} {H}^{′ k} \\ = {C}_{0} + {C}_{1} \cdot {L}^{′} + {C}_{2} \cdot {P}^{′} + {C}_{3} \cdot {H}^{′} + {C}_{4} \cdot {L}^{′} \cdot {P}^{′} + \\ {C}_{5} \cdot {L}^{′} \cdot {H}^{′} + {C}_{6} \cdot {P}^{′} \cdot {H}^{′} + {C}_{7} \cdot {L}^{′2} + {C}_{8} \cdot {P}^{′2} + \\ {C}_{9} \cdot {H}^{′2} + {C}_{10} \cdot {L}^{′} \cdot {P}^{′} \cdot {H}^{′} + {C}_{11} \cdot {L}^{′3} + {C}_{12} \cdot \\ {L}^{′} \cdot {P}^{′2} + {C}_{13} \cdot {L}^{′} \cdot {H}^{′2} + {C}_{14} \cdot {L}^{′2} \cdot {P}^{′} + {C}_{15} \cdot \\ {P}^{′3} + {C}_{16} \cdot {P}^{′} \cdot {H}^{′2} + {C}_{17} \cdot {L}^{′2} \cdot {H}^{′} + {C}_{18} \cdot {P}^{′2} \cdot \\ {H}^{′} + {C}_{19} \cdot {H}^{′3} .\end{matrix} \qquad ( 38 )$$

In each polynomial, functions of the original object-space coordinates may be substituted for the intermediate object-space coordinates. As such, the determination of the set of new coefficients begins with selecting one of the four polynomials (step 602). For the selected polynomial, functions of the original object-space coordinates may be substituted for the intermediate object-space coordinates (step 604). In particular, corresponding to equation (6), which defines herein-proposed rigorous refinements to the RPC model for a frame camera, each P′ in equation (38) may be replaced with the corresponding terms from the right side of equation (7). Likewise, each L′ and H′ in equation (38) may be replaced by corresponding terms from the right side of equations (8) and (9).

As has been illustrated, each polynomial has 20 terms, where each term is defined by one of 20 products of object-space coordinates of various powers, P¹L^{j}H^{k}, and a corresponding coefficient, Cᵢⱼₖ. After the substitution of step 602, it can be shown that there will continue to be 20 terms. For example, in the eighth term, the substitution leads to:

$$\begin{matrix}{C}_{7} {L}^{′2} = {C}_{7} {L}_{0}^{2} + 2 {C}_{7} {L}_{0} ( 1 + {s}_{2} ) {m}_{21} P + 2 {C}_{7} {L}_{0} ( 1 + {s}_{2} ) {m}_{22} L + \\ 2 {C}_{7} {L}_{0} ( 1 + {s}_{2} ) {m}_{23} H + 2 {{C}_{7} ( 1 + {s}_{2} )}^{2} {m}_{21} {m}_{22} PL + \\ 2 {{C}_{7} ( 1 + {s}_{2} )}^{2} {m}_{21} {m}_{23} PH + 2 {{C}_{7} ( 1 + {s}_{2} )}^{2} {m}_{22} {m}_{23} LH + \\ {{C}_{7} ( 1 + {s}_{2} )}^{2} {m}_{21}^{2} {P}^{2} + {{C}_{7} ( 1 + {s}_{2} )}^{2} {m}_{22}^{2} {L}^{2} + {C}_{7} ( 1 + \\ { {s}_{2} )}^{2} {m}_{23}^{2} {H}^{2} .\end{matrix} \qquad ( 39 )$$

Subsequently, one of the 20 products of object-space coordinates is selected (step 606) and the coefficients of the selected product of object-space coordinates are summed (step 608). Such summing acts to amalgamate the translating factors, (P₀,L₀,H₀), the scaling factors, (s₁,s₂,s₃), and the rotating factors, (m₁₁,m₁₂,m₁₃,m₂₁,m₂₂,m₂₃,m₃₁,m₃₂,m₃₃), into a new coefficient, C′ᵢⱼₖ.

It may then be determined whether all 20 of the products of object-space coordinates have been considered (step 610). If all 20 products of object-space coordinates have not been considered, another product of object-space coordinates is selected (step 604) for summing of coefficients (step 606). If all 20 products of object-space coordinates have been considered, the set of 20 new coefficients may be considered to define a new polynomial corresponding to the selected polynomial. It is then determined whether all four polynomials have been considered (step 612). If all four polynomials have not been considered, another of the polynomials is selected (step 602) and 20 new coefficients are determined for the selected polynomial. If all four polynomials have been considered, it is considered that a new, refined RPC camera model has been completely defined in the form of four new polynomials, each defined by 20 new coefficients.

Each new polynomial may be expressed in terms of the original object-space coordinates (P,L,H) as follows:

$$\begin{matrix}{ρ}^{′} ( P , L , H ) = {\sum }_{i = 0}^{N - j - k} {\sum }_{j = 0}^{N - i - k} {\sum }_{k = 0}^{N - i - j} {C}_{ijk}^{′} {P}^{i} {L}^{j} {H}^{k} \\ = {C}_{0}^{′} + {C}_{1}^{′} \cdot L + {C}_{2}^{′} \cdot P + {C}_{3}^{′} \cdot H + {C}_{4}^{′} \cdot L \cdot P + {C}_{5}^{′} \cdot \\ L \cdot H + {C}_{6}^{′} \cdot P \cdot H + {C}_{7}^{′} \cdot {L}^{2} + {C}_{8}^{′} \cdot {P}^{2} + {C}_{9}^{′} \cdot {H}^{2} + \\ {C}_{10}^{′} \cdot L \cdot P \cdot H + {C}_{11}^{′} \cdot {L}^{3} + {C}_{12}^{′} \cdot {L}^{′} \cdot {P}^{2} + {C}_{13}^{′} \cdot L \cdot \\ {H}^{2} + {C}_{14}^{′} \cdot {L}^{2} \cdot P + {C}_{15}^{′} \cdot {P}^{3} + {C}_{16}^{′} \cdot P \cdot {H}^{2} + {C}_{17}^{′} \cdot \\ {L}^{2} \cdot H + {C}_{18}^{′} \cdot {P}^{2} \cdot H + {C}_{19}^{′} \cdot {H}^{3}\end{matrix} \qquad ( 40 )$$

where C′ᵢⱼₖ are new coefficients that incorporate the translating factors, the scaling factors and the rotating factors. The new polynomial ρ′(P,L,H) has the same order and form as the original polynomial ρ(P,L,H) used in the provided RPC camera model.

In the new, refined RPC camera model, the image-space coordinates are determined (step 506) as follows:

$$\begin{matrix}X = \frac{{ρ}_{1}^{′} ( P , L , H )}{{ρ}_{2}^{′} ( P , L , H )} & ( 41 ) \\ Y = \frac{{ρ}_{3}^{′} ( P , L , H )}{{ρ}_{4}^{′} ( P , L , H )} & ( 42 )\end{matrix}$$

where each of the polynomials has a structure given by equation (40).

In the new, refined RPC camera model, except for the first coefficient of ρ′₂(P,L,H) and the first coefficient of ρ′₄(P,L,H) (both of which are known to be unity), the other 78 coefficients are very likely to be different from the coefficients in the original RPC camera model. More importantly, the new, refined RPC camera model has the same degree of rigor as the original RPC camera model.

As an alternative to equation (23), which defines herein-proposed rigorous refinements to the RPC model for a pushbroom camera, each P′ in equation (38) may be replaced with the corresponding terms from the right side of equation (24). Likewise, each L′ and H′ in equation (38) may be replaced by corresponding terms from the right side of equations (25) and (26). Subsequently, like terms may be gathered and the translating factors, (P₀,L₀,H₀), and the skew factors, (cos γ,sin γ), may be amalgamated into a new set of coefficients.

Further alternatively, corresponding to equation (27), which defines herein-proposed semi-rigorous refinements to the RPC model, each P′ in equation (38) may be replaced with the corresponding terms from the right side of equation (31). Likewise, each L′ and H′ in equation (38) may be replaced by corresponding terms from the right side of equations (32) and (33). Subsequently, like terms may be gathered and the 12 adjustable coefficients a₀, a₁, a₂, a₃, b₀, b₁, b₂, b₃, c₀, c₁, c₂ and c₃ in equations (31), (32) and (33) may be amalgamated into a new set of coefficients.

Notably, in all three alternatives, the expressions for P′, L′ and H′ contain only constant and first order (linear) terms of P, L and H.

The following set of coefficients are provided as may be received as an original RPC camera model.
LINE_OFF: −005395.00 pixels
SAMP_OFF: +006315.00 pixels
LAT_OFF: +01.48880000 degrees
LONG_OFF: +103.76360000 degrees
HEIGHT_OFF: +0014.000 meters
LINE_SCALE: +002089.00 pixels
SAMP_SCALE: +006646.00 pixels
LAT_SCALE: +00.01910000 degrees
LONG_SCALE: +000.06030000 degrees
HEIGHT_SCALE: +0160.000 meters
LINE_NUM_COEFF_{—}1: −4.058088031763146E−03
LINE_NUM_COEFF_{—}2: +1.863266429901583E−03
LINE_NUM_COEFF_{—}3: −1.011075674693225E+00
LINE_NUM_COEFF_{—}4: +1.037909446896945E−02
LINE_NUM_COEFF_{—}5: +1.073588150083391E−02
LINE_NUM_COEFF_{—}6: −6.802952774809191E−05
LINE_NUM_COEFF_{—}7: 2.931779142972081E−04
LINE_NUM_COEFF_{—}8: −6.167734739541919E−05
LINE_NUM_COEFF_{—}9: +4.837803260076617E−03
LINE_NUM_COEFF_{—}10: −4.235069601072972E−06
LINE_NUM_COEFF_{—}11: −2.510607234607580E−06
LINE_NUM_COEFF_{—}12: +4.617806294989660E−07
LINE_NUM_COEFF_{—}—: −4.177259907376756E-05
LINE_NUM_COEFF_{—}14: −3.835912272659498E−08
LINE_NUM_COEFF_{—}15: +3.000730062395898E−06
LINE_NUM_COEFF_{—}16: −1.636240768176174E−05
LINE_NUM_COEFF_{—}17: −1.627882435874965E−08
LINE_NUM_COEFF_{—}18: +3.078498832243188E−06
LINE_NUM_COEFF_{—}19: +1.781478686751409E−07
LINE_NUM_COEFF_{—}20: 7.050730056733126E−10
LINE_DEN_COEFF_{—}1: +1.000000000000000E+00
LINE_DEN_COEFF_{—}2: −1.060435877597646E−02
LINE_DEN_COEFF_{—}3: −4.794744011598974E−03
LINE_DEN_COEFF_{—}4: −9.106145285414067E−04
LINE_DEN_COEFF_{—}5: +4.129885463299448E−05
LINE_DEN_COEFF_{—}6: +6.388130628393182E−06
LINE_DEN_COEFF_{—}7: +2.536997852060483E−06
LINE_DEN_COEFF_{—}8: −3.435346063503073E−06
LINE_DEN_COEFF_{—}9: +1.622817761386760E−05
LINE_DEN_COEFF_{—}10: +2.560803065785427E−07
LINE_DEN_COEFF_{—}11: −1.248774369964645E−08
LINE_DEN_COEFF_{—}12: +3.194684382218657E−09
LINE_DEN_COEFF_{—}13: −1.217655728378117E−11
LINE_DEN_{—COEFF}_{—}14: −1.057282828115345E−09
LINE_DEN_COEFF_{—}15: +2.074885687806813E−09
LINE_DEN_COEFF_{—}16: −1.958161971686587E−10
LINE_DEN_COEFF_{—}17: −3.631711883560140E−10
LINE_DEN_COEFF_{—}18: −2.670201912517957E−09
LINE_DEN_COEFF_{—}19: −5.451725257172419E−09
LINE_DEN_COEFF_{—}20: −2.481870715555834E−11
SAMP_NUM_COEFF_{—}1: −7.232020293054972E−04
SAMP_NUM_COEFF_{—}2: +1.009635275114399E+00
SAMP_NUM_COEFF_{—}3: +1.853147105741170E−04
SAMP_NUM_COEFF_{—}4: −1.009162684012875E−02
SAMP_NUM_COEFF_{—}5: −4.846947626811018E−03
SAMP_NUM_COEFF_{—}6: −5.464300952972728E−04
SAMP_NUM_COEFF_{—}7: +7.027741674271956E−05
SAMP_NUM_COEFF_{—}8: −1.071816035476861E−02
SAMP_NUM_COEFF_{—}9: +6.332247928328239E−07
SAMP_NUM_COEFF_{—}10: +6.583873632181738E−06
SAMP_NUM_COEFF_{—}11: +7.761200720313651E−07
SAMP_NUM_COEFF_{—}12: −3.156909430142540E−06
SAMP_NUM_COEFF_{—}13: +1.634229214383203E−05
SAMP_NUM_COEFF_{—}14: +4.700109120979053E−08
SAMP_NUM_COEFF_{—}15: +4.178925367035273E−05
SAMP_NUM_COEFF_{—}16: −4.633906820289127E-09
SAMP_NUM_COEFF_{—}17: −1.689703315100019E−08
SAMP_NUM_COEFF_{—}18: +3.255809882472305E−06
SAMP_NUM_COEFF_{—}19: −2.778093068883391E−07
SAMP_NUM_COEFF_{—}20: −9.524990708368855E−10
SAMP_DEN_COEFF_{—}1: +1.000000000000000E+00
SAMP_DEN_COEFF_{—}2: −1.060435877597601E−02
SAMP_DEN_COEFF_{—}3: −4.794744011598974E−03
SAMP_DEN_COEFF_{—}4: −9.106145285414067E−04
SAMP_DEN_COEFF_{—}5: +4.129885463299448E−05
SAMP_DEN_COEFF_{—}6: +6.388130628393182E−06
SAMP_DEN_COEFF_{—}7: +2.536997852060483E−06
SAMP_DEN_COEFF_{—}8: −3.435346063503073E−06
SAMP_DEN_COEFF_{—}9: +1.622817761386760E−05

SAMP_DEN_COEFF_{—}10: +2.560803065785427E−07
SAMP_DEN_COEFF_{—}11: −1.248774369964645E−08
SAMP_DEN_COEFF_{—}12: +3.194684382218657E−09
SAMP_DEN_COEFF_{—}13: −1.217655728378117E−11
SAMP_DEN_COEFF_{—}14: −1.057282828115345E−09
SAMP_DEN_COEFF_{—}15: +2.074885687806813E−09
SAMP_DEN_COEFF_{—}16: −1.958161971686587E−10
SAMP_DEN_COEFF_{—}17: −3.631711883560140E−10
SAMP_DEN_COEFF_{—}18: −2.670201912517957E−09
SAMP_DEN_COEFF_{—}9: −5.451725257172419E−09
SAMP_DEN_COEFF_{—}20: −2.481870715555834E−11
In particular, SAMP_NUM_COEFF_{—}1-20=C₀₋₁₉ for ρ₁, SAMP_DEN_COEFF_{—}1-20=C₀₋₁₉ for ρ₂, LINE_NUM_COEFF_{—}1-20=C₀₋₁₉ for ρ₃ and LINE_DEN_COEFF_{—}1-20=C₀₋₁₉ for ρ₄. Additionally, the linear scaling factors for latitude, longitude and height are represented by LAT_SCALE, LONG_SCALE and HEIGHT_SCALE, respectively, and the linear translation factors for latitude, longitude and height are represented by LAT_OFF, LONG_OFF and HEIGHT_OFF, respectively. These linear scaling factors and linear translation factors are used to normalize the actual object-space coordinates to arrive at normalized object-space coordinates to which the RPC model is applied, as follows:

$${P}_{normalized} = \frac{{P}_{actual} - LAT\_OFF}{LAT\_SCALE} , \\ {L}_{normalized} = \frac{{L}_{actual} - LONG\_OFF}{LONG\_SCALE} and$$

$${H}_{normalized} = \frac{{H}_{actual} - HEIGHT\_OFF}{HEIGHT\_SCALE} .$$

Additionally, the normalized image-space coordinates produced through application of an RPC camera model may be converted as follows:
X_{actual}=(X_{normalized}×SAMP_SCALE)+SAMP_OFF
Y_{actual}=(Y_{normalized}×LINE_SCALE)+LINE_OFF.

The following set of coefficients are provided as may be determined as a new, refined RPC camera model for a pushbroom camera, where the coefficients are determined from application of the structure given by equation (40) to the coefficients provided above along with a set of translating factors, (P₀,L₀,H₀), scaling factors, (s₁,s₂,s₃), and rotation angles, (ω,φ,κ).
LINE_OFF: −005395.00 pixels
SAMP_OFF: +006315.00 pixels
LAT_OFF: +01.48880000 degrees
LONG_OFF: +103.76360000 degrees
HEIGHT_OFF: +0014.000 meters
LINE_SCALE: +002089.00 pixels
SAMP_SCALE: +006646.00 pixels
LAT_SCALE: +00.01910000 degrees
LONG_SCALE: +000.06030000 degrees
HEIGHT_SCALE: +0160.000 meters
S1: 1.060350E−05
S2: 6.850839E−06
S3: 4.809924E−01
OMEGA: 6.662572E−03
KAPPA: −1.018978E−04
PHI: −4.919486E−03
P0: 2.355817E−03
L0: −1.890136E−03
H0: −1.633305E−01
LINE_NUM_COEFF_{—}1: −3.370950065448345E−03
LINE_NUM_COEFF_{—}2: +1.685962634540268E−03
LINE_NUM_COEFF_{—}3: −1.010836423770928E+00
LINE_NUM_COEFF_{—}4: +8.641917949675209E—03
LINE_NUM_COEFF_{—}5: +1.072954660012162E−02
LINE_NUM_COEFF_{—}6: −2.967076842853633E−05
LINE_NUM_COEFF_{—}7: +5.513088123929027E−04
LINE_NUM_COEFF_{—}8: −6.218319007523237E−05
LINE_NUM_COEFF_{—}9: +4.822667197484585E−03
LINE_NUM_COEFF_{—}10: −6.323346956163217E−06
LINE_NUM_COEFF_{—}11: −4.240656427711135E−06
LINE_NUM_COEFF_{—}12: +4.392793128424132E−07
LINE_NUM_COEFF_{—}13: −4.166935437734998E−05
LINE_NUM_COEFF_{—}14: −6.565532275752027E−08
LINE_NUM_COEFF_{—}15: +2.927337277416563E−06
LINE_NUM_COEFF_{—}16: −1.633667923697682E−05
LINE_NUM_COEFF_{—}17: −5.534695164565017E−08
LINE_NUM_COEFF_{—}18: +4.583111106559388E−06
LINE_NUM_COEFF_{—}19: −2.655994827308424E−07
LINE_NUM_COEFF_{—}20: +1.623885828936428E−09
LINE_DEN_COEFF_{—}1: +1.000000000000000E+00
LINE_DEN_COEFF_{—}2: −1.059539085213011E−02
LINE_DEN_COEFF_{—}3: −4.765367887586591E−03
LINE_DEN_COEFF_{—}4: −1.432215579868122E−03
LINE_DEN_COEFF_{—}5: +4.108581346485825E−05
LINE_DEN_COEFF_{—}6: +9.691453486399339E-06
LINE_DEN_COEFF_{—}7: +4.149309623514571E−06
LINE_DEN_COEFF_{—}8: −3.475423417201609E−06
LINE_DEN_COEFF_{—}9: +1.613586889349427E−05
LINE_DEN_COEFF_{—}10: +6.348175801037536E−07
LINE_DEN_COEFF_{—}11: −1.835982822028851E−08
LINE_DEN_COEFF_{—}12: +3.212220734141958E−09
LINE_DEN_COEFF_{—}13: +3.624154527381614E−10
LINE_DEN_COEFF_{—}14: −2.477337520225370E−09
LINE_DEN_COEFF_{—}15: +2.233214183880647E−09
LINE_DEN_COEFF_{—}16:−4.884035757030812E−11
LINE_DEN_COEFF_{—}17:−9.883433002813063E−10
LINE_DEN_COEFF_{—}18: −3.868418893148365E−09
LINE_DEN_COEFF_{—}19: −8.031537736835294E−09
LINE_DEN_COEFF_{—}20: −9.829680383549699E−11
SAMP_NUM_COEFF_{—}1: −7.741059689287397E−04
SAMP_NUM_COEFF_{—}2: +1.009552682602108E+00
SAMP_NUM_COEFF_{—}3: +1.758125060508887E−04
SAMP_NUM_COEFF_{—}4: −9.976454413510015E−03
SAMP_NUM_COEFF_{—}5: −4.824200541554128E-03
SAMP_NUM_COEFF_{—}6: −9.465772143622239E−04
SAMP_NUM_COEFF_{—}7: +7.998567210846011E−05
SAMP_NUM_COEFF_{—}8: −1.070992718394708E−02
SAMP_NUM_COEFF_{—}9: +9.417144475293307E−08
SAMP_NUM_COEFF_{—}10: +1.072946392736784E−05
SAMP_NUM_COEFF_{—}11: +1.769436052898518E−06
SAMP_NUM_COEFF_{—}12: −3.175752078858237E−06
SAMP_NUM_COEFF_{—}13: +1.628479266781125E−05
SAMP_NUM_COEFF_{—}14: +1.613150912969493E−07
SAMP_NUM_COEFF_{—}15: +4.166654676324974E−05
SAMP_NUM_COEFF_{—}16: −1.497845252226348E−09
SAMP_NUM_COEFF_{—}17: −3.465829820480594E−08
SAMP_NUM_COEFF_{—}18: +5.048759076702918E−06
SAMP_NUM_COEFF_{—}9: −3.299126588098424E−07
SAMP_NUM_COEFF_{—}20: −2.685374498829963E−09
SAMP_DEN_COEFF_{—}1: +1.000000000000000E+00
SAMP_DEN_COEFF_{—}2: −1.059539085213011E−02
SAMP_DEN_COEFF_{—}3: −4.765367887586591E−03
SAMP_DEN_COEFF_{—}4: −1.432215579868122E−03
SAMP_DEN_COEFF_{—}5: +4.108581346485825E−05
SAMP_DEN_COEFF_{—}6: +9.691453486399339E−06
SAMP_DEN_COEFF_{—}7: +4.149309623514571E−06
SAMP_DEN_COEFF_{—}8: −3.475423417201609E−06
SAMP_DEN_COEFF_{—}9: +1.613586889349427E−05
SAMP_DEN_COEFF_{—}10: +6.348175801037536E−07
SAMP_DEN_COEFF_{—}11: −1.835982822028851E−08
SAMP_DEN_COEFF_{—}12: +3.212220734141958E−09
SAMP_DEN_COEFF_{—}13: +3.624154527381614E−10
SAMP_DEN_COEFF_{—}14: −2.477337520225370E−09
SAMP_DEN_COEFF_{—}15: +2.233214183880647E−09
SAMP_DEN_COEFF_{—}16:−4.884035757030812E−11
SAMP_DEN_COEFF_{—}17: −9.883433002813063E−10
SAMP_DEN_COEFF_{—}18: −3.868418893148365E−09
SAMP_DEN_COEFF_{—}19: −8.031537736835294E−09
SAMP_DEN_COEFF_{—}20: −9.829680383549699E−b 11

The rotating factors, (m₁₁,m₁₂,m₁₃,m₂₁,m₂₂,m₂₃,m₃₁,m₃₂,m₃₃), are calculated from the rotation angles according to equation (10). More particularly, the intermediate object-space coordinates (P′,L′,H′) may be determined using the rigorous equations (7), (8) and (9) with the 12 adjustable coefficients taking on values as follows:

| | | | |
|---|---|---|---|
| a₀ = 2.355817E−3; | a₁ = −1.15968E−5; | a₂ = 6.91212E−5; | a₃ = 6.661834E−3; |
| b₀ = −1.890136E−3; | b₁ = −1.01896E−4; | b₂ = −5.25174E−6; | b₃ = 4.91882E−3; |
| c₀ = −1.63330502E−1; | c₁ = −9.867145E−3; | c₂ = 7.28553E−3; | c₃ = 4.8094164E−1 |

The intermediate object-space coordinates (P′,L′,H′) may then be used in the provided polynomials (ρ₁,ρ₂,ρ₃,ρ₄), for which a set of coefficients are provided in the first set of coefficients listed above, according to equation (38) to determine new polynomials (ρ′₁,ρ′₂,ρ′₃,ρ′₄) for which a set of determined coefficients are provided in the second set of coefficients listed above.

For an exemplary ground control point, actual object-space coordinates specifying Latitude: 1.319205722, Longitude: 103.7496795 and Height: 87.6877 may be received in association with a pair of actual image-space coordinates specifying Pixel Sample=4719 and Line=13364. The actual object-space coordinates may be normalized, using the linear scaling factors and linear translation factors, to give values for (P,L,H) as (−8.879281571, −0.230854063, 0.460548125). Where the normalized object-space coordinates are used in the original RPC camera model defined by the coefficients given in the first set of coefficients listed above, normalized image-space coordinates (X, Y) result as (−0.239850007, 8.983131978). When the linear scaling factors and linear translation factors are removed, the resulting actual image-space coordinates specify Pixel Sample=4720.96 and Line=13370.76.

An error may be determined between the image-space coordinates determined using the original RPC camera model and the known actual image-space coordinates. In this case, the error is 1.96 pixels and 6.76 lines.

Where the normalized object-space coordinates are used in the new, refined RPC camera model defined by the coefficients given in the second set of coefficients listed above, normalized image-space coordinates (X, Y) result as (−0.240081859, 8.979844293). When the linear scaling factors and linear translation factors are removed, the resulting actual image-space coordinates specify Pixel Sample=4719.42 and Line=13363.89.

An error may also be determined between the image-space coordinates determined using the new, refined RPC camera model and the known actual image-space coordinates. In this case, the error is 0.42 pixels and 0.11 lines. Evidently, the refined RPC camera model has improved the accuracy of the image-space coordinates determined from the provided object-space coordinates.

As will be apparent to those of ordinary skill in the art, the methods provided herein may most efficiently be performed by a processor in an image processing workstation or other processing device such as a general purpose computer. Software for executing methods exemplary of this invention on such a processor may be loaded from a computer readable medium which could be a disk, a tape, a chip or a random access memory containing a file downloaded from a remote source.

Other modifications will be apparent to those skilled in the art and, therefore, the invention is defined in the claims.

1. A method of refining a Rational Polynomial Coefficient (RPC) camera model, said method comprising:
receiving an original plurality of coefficients defining an original Rational Polynomial Coefficient (RPC) camera model for determining image-space coordinates from object-space coordinates defined for an original object-space coordinate system;
determining a plurality of physical parameters for transforming said original object-space coordinate system to an intermediate object-space coordinate system; and
based on said plurality of physical parameters and said original plurality of coefficients, determining a refined plurality of coefficients defining a refined RPC camera model.

2. The method of claim 1 further comprising:
receiving a plurality of known object-space coordinates in said original object-space coordinate system and a plurality of known image-space coordinates corresponding to said plurality of known object-space coordinates;
applying said refined RPC camera model to said plurality of known object-space coordinates to determine a plurality of determined image-space coordinates; and
determining a plurality of differences between said plurality of determined image-space coordinates and said plurality of known image-space coordinates;
where said determining said plurality of physical parameters acts to minimize said plurality of differences.

3. The method of claim 1 wherein said plurality of physical parameters includes a translation factor such that, through the application of said translation factor, said intermediate object-space coordinate system is translated relative to said original object-space coordinate system.

4. The method of claim 1 wherein said plurality of physical parameters include a rotation angle such that, through the application of said rotation angle, said intermediate object-space coordinate system is rotated relative to said original object-space coordinate system.

5. The method of claim 4 wherein said rotation angle is a pitch angle.

6. The method of claim 4 wherein said rotation angle is a roll angle.

7. The method of claim 4 wherein said rotation angle is a yaw angle.

8. The method of claim 1 wherein said plurality of physical parameters include a scaling factor such that, through the application of said scaling factor, said intermediate object-space coordinate system is scaled relative to said original object-space coordinate system.

9. A computer readable medium containing computer-executable instructions which, when performed by a processor, cause the processor to:
receive an original plurality of coefficients defining an original Rational Polynomial Coefficient (RPC) camera model for determining image-space coordinates from object-space coordinates defined for an original object-space coordinate system;
determine a plurality of physical parameters for transforming said original object-space coordinate system to an intermediate object-space coordinate system; and
based on said plurality of physical parameters and said original plurality of coefficients, determine a refined plurality of coefficients defining a refined RPC camera model.

10. A method of refining a Rational Polynomial Coefficient (RPC) camera model, said method comprising:
receiving an original plurality of coefficients defining an original Rational Polynomial Coefficient (RPC) camera model for determining image-space coordinates from object-space coordinates defined for an original object-space coordinate system;
receiving a plurality of known object-space coordinates in said original object-space coordinate system and a plurality of known image-space coordinates corresponding to said plurality of known object-space coordinates;
determining a plurality of physical parameters for transforming said original object-space coordinate system to an intermediate object-space coordinate system to reduce a difference between:
said known image-space coordinates; and
a plurality of image-space coordinates determined through application of said original RPC camera model to object-space coordinates of said known object-space coordinates that correspond to said known image-space coordinates and have been transformed to said intermediate object space coordinate system; and
based on said plurality of physical parameters and said original plurality of coefficients, determining a refined plurality of coefficients defining a refined RPC camera model.

11. A computer readable medium containing computer-executable instructions which, when performed by a processor, cause the processor to:
receive an original plurality of coefficients defining an original Rational Polynomial Coefficient (RPC) camera model for determining image-space coordinates from object-space coordinates defined for an original object-space coordinate system;
receive a plurality of known object-space coordinates in said original object-space coordinate system and a plurality of known image-space coordinates corresponding to said plurality of known object-space coordinates;
determine a plurality of physical parameters for transforming said original object-space coordinate system to an intermediate object-space coordinate system to reduce a difference between:
said known image-space coordinates; and
a plurality of image-space coordinates determined through application of said original RPC camera model to object-space coordinates of said known object-space coordinates that correspond to said known image-space coordinates and have been transformed to said intermediate object space coordinate system; and
determine a refined plurality of coefficients defining a refined RPC camera model based on said plurality of physical parameters and said original plurality of coefficients.

12. A method of determining a pair of image-space coordinates, said method comprising:
receiving a plurality of coefficients defining a Rational Polynomial Coefficient (RPC) camera model;
receiving a plurality of values for original object-space coordinates, where said plurality of values for original object-space coordinates are defined for an original object-space coordinate system;
determining values for a plurality of intermediate object-space coordinates in an intermediate object-space coordinate system, where said intermediate object-space coordinate system is adjusted relative to said original object-space coordinate system; and
utilizing said values for said plurality of intermediate object-space coordinates in said RPC camera model to obtain a pair of image-space coordinates.

13. The method of claim 12 wherein said intermediate object-space coordinate system is translated relative to said original object-space coordinate system.

14. The method of claim 13 wherein said determining comprises adding a first translating factor to a first original object-space coordinate among said plurality of original object-space coordinates to obtain a first intermediate object-space coordinate among said intermediate object-space coordinates.

15. The method of claim 12 wherein said intermediate object-space coordinate system is rotated relative to said original object-space coordinate system.

16. The method of claim 15 wherein said determining comprises multiplying, by a first rotating factor, a first original object-space coordinate among said plurality of original object-space coordinates to obtain a first intermediate object-space coordinate among said intermediate object-space coordinates.

17. The method of claim 16 further comprising:
selecting a pitch angle;
selecting a roll angle;
selecting a yaw angle; and
determining said rotating factor from a predetermined function of said pitch angle, said roll angle and said yaw angle.

18. The method of claim 12 wherein said intermediate object-space coordinate system is scaled relative to said original object-space coordinate system.

19. The method of claim 18 wherein said determining comprises multiplying, by a first scaling factor, a first original object-space coordinate among said plurality of original object-space coordinates to obtain a first intermediate object-space coordinate among said intermediate object-space coordinates.

20. A computer readable medium containing computer-executable instructions which, when performed by a processor, cause the processor to:
receive a plurality of coefficients defining a Rational Polynomial Coefficient (RPC) camera model;
receive a plurality of values for original object-space coordinates, where said plurality of values for original object-space coordinates are defined for an original object-space coordinate system;
determine values for a plurality of intermediate object-space coordinates in an intermediate object-space coordinate system, where said intermediate object-space coordinate system is adjusted relative to said original object-space coordinate system; and
utilize said values for said plurality of intermediate object-space coordinates in said RPC camera model to obtain a pair of image-space coordinates.
